(19) United States
(12) Patent Application Publication
(10) Pub. No.: US 2002/0070950 A1
(43) Pub. Date: Jun. 13, 2002

(54) A METHOD OF EFFECTING A STEREOSCOPIC DISPLAY

(76) Inventor: MATTHIAS HAMMER, WESTERHAM (DE)

Correspondence Address: KARL F MILDE JR, MILDE HOFFBERG & MACKLIN, 10 BANK STREET, SUITE 460, WHITE PLAINS, NY, 10606

(21) Appl. No.: 09/319,607

(22) PCT Filed: Jan. 7, 1998
(86) PCT No.: PCT/DE98/00067

(30) Foreign Application Priority Data
Jan. 10, 1997 (DE) 197 00 574.0

(51) Int. Cl. G09G 5/36

(52) U.S. Cl. 345/618

(57) ABSTRACT

In a method for the graphic representation of additional information that is available as a two-dimensional representation per se, and theat supplements a stereoscopically represented area, the additional information is pictured in a depth of a represented area, which is in a predetermined relationship with the depth of the existing objects in the represented area. Furthermore, the invention comprises a method for representing objects which are situated behind the observer, a method in which the depth of the area can be represented as wider than it is in reality.

This invention relates to a method of graphically displaying additional information which in itself exists as a two-dimensional representation, in addition to a stereoscopically displayed space.

With increasing progress in the display of information by means of computers and suitable image reproduction devices, the stereoscopic display of spaces or of objects which are present in a space is also becoming important. Other information—hereinafter called additional information—frequently has to be displayed in the field of view of an observer, wherein the same image reproduction device can advantageously be used.

Thus, for example, a method and a device for the display of flight guidance information with a three-dimensional display of the air space comprising at least one horizon and the precalculated flight path of the aircraft have become known from EP 0 418 558 A2 and U.S. Pat. No. 5,420,582. The display of the air space can contain various objects such as the ground, the take-off and landing runways, or buildings, which are reproduced either in perspective on a flat screen or stereoscopically. So as to be able to take in other indications at a glance, this known device comprises the display of various scales on the screen as additional information. In itself, this additional information is in fact only two-dimensional, and in a stereoscopic display of the air space can cause irritation to the observer—particularly due to additional inclination movements of the eyes when there is a change of the observer's attention between the additional information and objects of the stereoscopic display.

The object of the present invention is to facilitate the reception of all the information in a stereoscopic display of a space, including additional information which in itself is two-dimensional, and to make it possible to work with displays of this type in a fatigue-free manner.

This object is achieved according to the invention by depicting the additional information at a depth of the displayed space which is in a predetermined relationship to the depth of objects present in the displayed space.

In essence, the invention can be realised by providing the additional information with a parallax, i.e. by displaying it displaced for the left and right eye corresponding to the plane of depth in which the additional information is to be displayed. At the same time, it is not impossible for spatial attributes (scales, pointers, warning indications) to be imparted to the displays of additional information, such as a defined thickness or shading for example. The additional information can also be situated in a plurality of planes.

All known and future devices for stereoscopic reproduction are suitable as image reproduction devices. Examples thereof include miniature display screens which are disposed on the observer's head and which can be observed via an eyepiece, systems with surrounding opaque screens in which the left and right eyes alternately observe a display screen, or systems comprising polarising spectacles.

The method according to the invention can advantageously be used wherever a stereoscopically displayed space is observed together with additional information. One intended application is for the guidance of a vehicle. In one embodiment of the invention, the stereoscopically displayed space is therefore situated in a direction of view in front of a vehicle, particularly an aircraft, and contains stereoscopically displayed objects which constitute guidance information, and the additional information is displayed at a depth which is in a logical relationship with said objects.

If the space, including the objects present therein, is calculated by a graphics computer in this embodiment, for example, information is also ultimately present regarding the importance of or the attention which should be paid to the objects present in the space. Thus in a simulated view from an aircraft, for example, a scale can be displayed in the plane of the windscreen of the aircraft to effect an adaptation to conditions of natural light. However, if the display of an object, e.g. a landing runway, necessitates particular attention due to the operating situation, it may definitely be advisable to depict the scale, including the associated pointer, at the depth of the landing strip.

In this embodiment it has proved to be particularly advantageous if the objects depict a predictor which denotes the estimated path of the vehicle, and if the depth of the additional information is in the region of the predictor. In this connection, the predictor preferably consists of a plurality of parts disposed one behind another, and the depth of the additional information is situated in the region of a first part which is situated nearest to the vehicle.

In the method according to the invention, however, it is not impossible for the additional information to be displayed somewhat in front of or behind the object in question, depending on the requirements which exist.

In another embodiment of the method according to the invention, the depth of the additional information can be varied and is matched to the depth of predetermined objects in the space. The additional information, together with spatially fixed objects, can thereby come closer to the aircraft and thus to the observer, particularly in a view from an aircraft in the direction of travel. At the same time, provision can be made in addition for one or more of a plurality of objects in the space to be selected as predetermined objects. This selection is made with the aid of information which is likewise stored in a computer. Thus, for example, a display which, together with a route marker, comes closer as regards its depth can jump to a following route marker when the first route marker moves out of the field of view.

In one advantageous embodiment of the method according to the invention, particularly important additional information is emphasised by displaying it in front of the screen of a stereoscopic image reproduction device, namely between the screen and the observer. Provision can also be made for particularly important additional information to be emphasised by displaying it at a varying depth, preferably with a decreasing depth (coming towards the observer).

For example, warning signals can be emphasised particularly clearly in relation to the other information which is displayed, optionally by moving them forwards from the depth of the image so that they “hit the observer straight in the eye”.

Another embodiment of the method according to the invention achieves the object of stereoscopically displaying objects situated behind the observer also. Objects such as these may be aircraft approaching from behind, for example. In a method for the display of objects in addition to a stereoscopically displayed space which is situated in front of an observer, whilst the objects are situated behind the observer, this object is achieved by the objects being displayed between the observer and the screen of a stereoscopic image reproduction device.

In this embodiment, a volume of visibility which comprises the objects and which extends as far as the plane of the screen starting from a viewpoint situated behind the observer is preferably reduced to a volume of visibility between the observer and the plane of the screen.

In one method for the stereoscopic display of a space which is situated in the direction of view in front of a vehicle, provision is made for the depth of the space to be displayed enlarged compared with reality. This method can also be employed with one or both of the aforementioned embodiments, and makes it possible to achieve better resolution of the depth, particularly of objects which are at a considerable distance.

Examples of embodiments of the invention are explained in greater detail below and are illustrated in the drawings, which comprise a plurality of Figures, where:

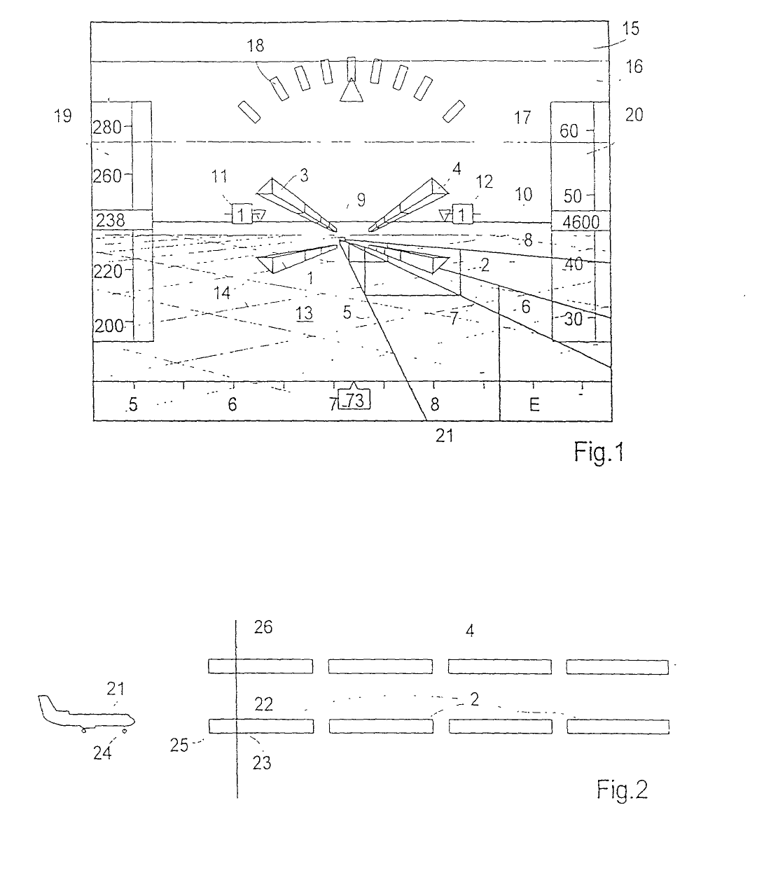

FIG. 1 is a display which serves to explain the invention;

FIG. 2 is a schematic illustration which serves to explains the information in the display;

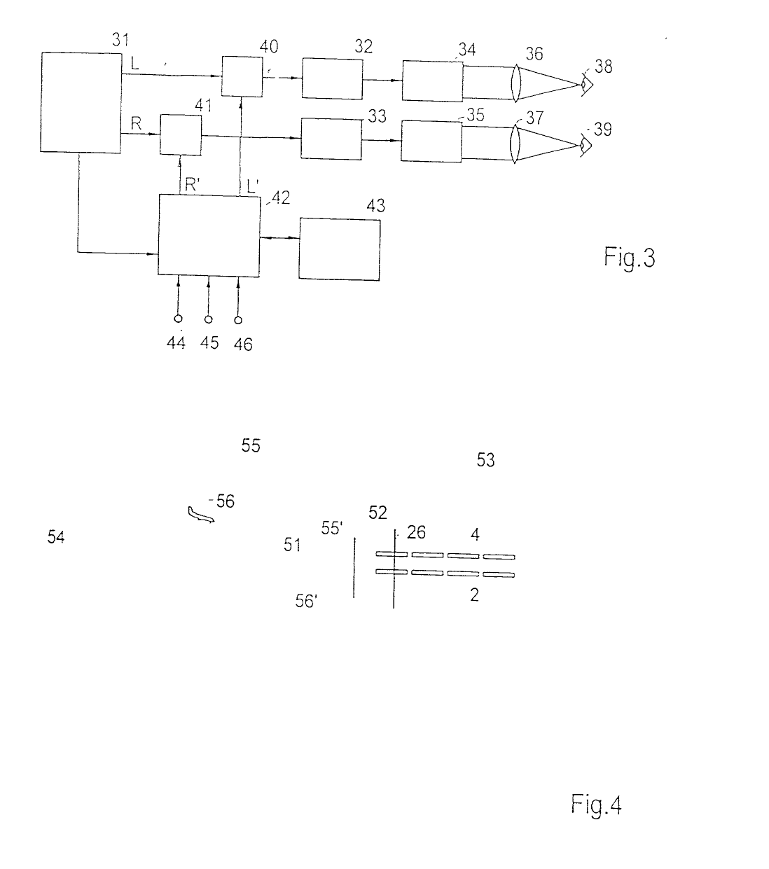

FIG. 3 is a block circuit diagram of a device for carrying out the method according to the invention; and

FIG. 4 is a schematic illustration of a further embodiment of the invention.

Identical parts are denoted by identical reference numerals in the Figures.

The flight situation illustrated in the display shown in FIG. 1 corresponds to a landing approach, wherein the precalculated flight path is displayed with the aid of a predictor, which consists of four bodies 1, 2, 3, 4, and with the aid of straight lines 5, 6, 7, 8 as the boundaries of an approach lane which the aircraft is approaching. On flying further in a straight line, the aircraft would land beside the landing runway, which is simply displayed as a rectangle 9.

A line 10 represents the horizon, and rectangles 11, 12 indicate the pitch angle by their distance from the horizon 10 and by the figures which are visible inside the rectangles. The ground 13 is provided with a grid 14 which is aligned in a north-south direction. The sky is displayed in the form of strips 15, 16, 17 of different shades of colour (darker and lighter blue, which are not visible in FIG. 1), in order to impart further information on the pitch angle. The ground 13 is preferably displayed in green or brown. Colours and levels of brightness are provided for the bodies 1 to 4, which are also hereinafter called predictors, which stand out against both the sky and the ground.

The other indications which are visible in the display shown in FIG. 1, particularly a roll angle indicator 18, a speed indicator 19, a height indicator 20 and a course indicator 21, are known in the art and in particular do not need to be explained in detail to provide an understanding of the invention.

The predictor illustrated in FIG. 1 comprises bodies 1 to 4 which are divided into a plurality of sub-bodies. However, a subdivision by means of individual lines, as has been effected in the illustration of FIG. 1, is not clearly visible at the given distance of observation on account of the limits of resolution of the image reproduction arrangement and of the human eye, particularly for those sub-bodies which are the furthest away. In practice, this division into sub-bodies is therefore effected by means of the shape thereof or by a colour progression.

In the side view of an aircraft 21 and of bodies 2, 4 which are transformed into reality which is illustrated in FIG. 2, the height of the body 2, and of the body on the left side of the flight path which is not visible in FIG. 2, is selected so that the top edge 22 thereof is situated at about the eye level of the pilot, whilst the bottom edge thereof assumes the height of the contact surface of the wheel 24. A line 26 characterises the depth in the sense of the distance from the observer of the indicators 18 to 21.

The display shown in FIG. 1 is a perspective representation, but the invention starts from a stereoscopic representation. The reproduction of a display such as this—which is in fact only possible as a two-dimensional representation anyway in the paper form which is necessary for patent applications—is essentially characterised in that two partial images are generated which do not differ from each other in the plane of the screen and which differ from each other by a greater parallax with increasing distance from the observer (depth). For example, if the indicators 18 to 21 are displayed at the same location for each of the partial images, they appear to the observer to be at an infinite distance, at the horizon for example.

However, in the interest of flight guidance with the aid of the predictor 1, it has proved to be advantageous if the indicators are disposed in the region of depth of the part 25 of the predictor which is situated nearest to them in each case. The parallax of the indicators, i.e. the horizontal displacement of one partial image in relation to the other, is therefore selected corresponding to the parallax within the region of depth of the parts 25 of the predictor facing the observer.

In addition to a choice of parallax which corresponds to the depth, it is necessary to mask objects situated one behind another according to their depth. For example, in the display shown in FIG. 1 it is assumed that the approach lane 5 to 8 continues from the landing runway 9 to a point behind the observer. The parts of the approach lane situated in the foreground of the image are accordingly situated nearer the observer than are the parts 25 of the predictor, and are thus also nearer than the indicators 18 to 21. The latter, however, are nearer to the observer than is the horizon, so that they in fact mask the horizon and are masked in turn by the lines of the approach lane.

The example of an embodiment shown in FIG. 3 is represented as a block circuit diagram. However, this does not mean that the device illustrated is limited to a form of production comprising individual circuits corresponding to the blocks shown. Rather, the device can be produced in a particularly advantageous manner by means of highly integrated circuits. Digital signal processors can then be used, which when suitably programmed perform the processing steps illustrated in the block circuit diagram.

In the embodiment of a device for carrying out the method according to the invention which is shown in FIG. 3, a graphics processor 31 is provided for the display of the air space and of objects situated therein, including the predictor 1 to 4 and the approach lane 5 to 8 (FIG. 1).

The graphics processor generates a left and a right partial image which are each stored in a memory 32, 33 and are fed to an image reproduction device 34, 35. The image reproduction devices 34, 35 can be observed by the left eye 38 and by the right eye 39, respectively, of an observer via eyepieces 36, 37.

In the devices 40, 41, the signals L, R which are generated by the graphics processor 31 are combined with signals L(, R( which are generated by a further graphics processor 42. The latter serves to generate the indicators 18 to 21. The elements which are necessary for this purpose are taken from a memory 43, whilst the quantities to be indicated (altitude, flying speed, location, etc.) are supplied by sensors 44 to 46. The further graphics processor 42 receives information from the graphics processor 31 on the depth of the indications to be displayed—and therefore receives information on the depth of the parts 25 of the predictor for the display shown in FIG. 1. For example, if in a different flight situation an indicator relating to the landing runway 9 is generated by the graphics processor 42, the depth of the landing runway 9 is communicated by the graphics processor 31 to the further graphics processor 42. In accordance with this information, this indicator is then displayed beside or above the landing runway.

The embodiment of the method according to the invention which is schematically illustrated in FIG. 4 enables objects to be made visible, for example aircraft, which are situated outside the volume of visibility 53 of an observer 51 and which in particular are situated behind the observer. The volume of visibility 53 results from the distance of observation of the observer 51 from the screen 52 and from the size of the screen and the scale of the displayed space. In the embodiment shown in FIGS. 1 and 2, the display of the predictor 2, 4 and of the indicators 26, amongst others, are situated inside the volume of visibility.

An imaginary observer 54 situated behind can register a volume of visibility 55 in which an aircraft 56 is located. The position and location of the aircraft 56 are transmitted to the aircraft in which the observer 51 is situated by measures which are known in the art, such as radar monitoring, and such as communications systems between the two aircraft and between the aircraft and ground stations. The volume of visibility 55, including the aircraft 56, is projected into a diminished volume of visibility 55′ between the observer 51 and the screen 52. Instead of the aircraft 56, the latter includes an aircraft symbol 56 which reproduces the position of the aircraft inside the volume of visibility 55 and its location.

1. A method of graphically displaying additional information which in itself exists as a two-dimensional representation, in addition to a stereoscopically displayed space, characterised in that the additional information is depicted at a depth of the displayed space which is in a predetermined relationship to the depth of objects present in the displayed space.

2. A method according to claim 1, characterised in that the stereoscopically displayed space is situated in a direction of view in front of a vehicle, particularly of an aircraft, and contains stereoscopically displayed objects which constitute guidance information, and that the additional information is displayed at a depth which is in a logical relationship with the objects.

3. A method according to claim 2, characterised in that the objects depict a predictor which denotes the estimated path of the vehicle, and that the depth of the additional information is in the region of the predictor.

4. A method according to claim 3, characterised in that the predictor consists of a plurality of parts disposed one behind another, and that the depth of the additional information is situated in the region of a first part which is situated nearest to the vehicle.

5. A method according to claim 1, characterised in that the depth of the additional information can be varied and is matched to the depth of predetermined objects in the space.

6. A method according to claim 5, characterised in that one or more of a plurality of objects in the space can be selected as predetermined objects.

7. A method according to any one of the preceding claims, characterised in that particularly important additional information is emphasised by displaying it in front of the screen of a stereoscopic image reproduction device.

8. A method according to any one of the preceding claims, characterised in that particularly important additional information is emphasised by displaying it at a varying depth, preferably with a decreasing depth (coming towards the observer).

9. A method for the display of objects in addition to a stereoscopically displayed space which is situated in front of an observer, whilst the objects are situated behind the observer, characterised in that the objects are displayed between the observer and the screen of a stereoscopic image reproduction device.

10. A method according to claim 9, characterised in that a volume of visibility which comprises the objects and which extends as far as the plane of the screen starting from a viewpoint situated behind the observer is reduced to a volume of visibility between the observer and the plane of the screen.

11. A method for the stereoscopic display of a space which is situated in the direction of view in front of a vehicle, characterised in that the depth of the space is displayed enlarged compared with reality.
